(19) United States
(12) Patent Application Publication
(10) Pub. No.: US 2008/0137858 A1
(43) Pub. Date: Jun. 12, 2008

(54) Single-channel transmission of qubits and classical bits over an optical telecommunications network

(75) Inventors: Robert Gelfond, New York, NY (US); A. Craig Beal, Watertown, MA (US); Audrius Berzanskis, Cambridge, MA (US); Joseph E. Gortych, Sarasota, FL (US)

Correspondence Address: OPTICUS IP LAW, PLLC, 7791 ALISTER MACKENZIE DRIVE, SARASOTA, FL, 34240, US

(73) Assignee: MAGIQ TECHNOLOGIES, INC.

(21) Appl. No.: 11/999,151

(22) Filed: Dec. 4, 2007

Related U.S. Application Data
(60) Provisional application No. 60/873,120, filed on Dec. 6, 2006.

(51) Int. Cl. H04L 9/06

(52) U.S. Cl. 380/256

(57) ABSTRACT

Systems and methods that allow for transmitting qubits and classical signal over the same channel of an optical telecommunications network that includes an optical fiber. The method includes sending the qubits of wavelength λ_{S} over a quantum optical path that includes the optical fiber during a time interval ΔT₀ when there are no classical optical signals of wavelength λ_{S} traveling over the optical fiber. The method also includes sending the classical signals over a classical optical path that includes the optical fiber, wherein the classical signals are sent outside of the time interval ΔT₀ to avoid interfering with the qubit transmission. Systems and methods for using the present invention to form quantum key banks for encrypting classical signals sent over the optical telecommunications network are also disclosed.

### CLAIM OF PRIORITY

This application claims the benefit of priority under 35 USC §119 from U.S. Provisional Patent Application Ser. No. 60/873,120, filed on Dec. 6, 2006, which application is incorporated by reference herein.

### FIELD OF THE INVENTION

The present invention relates generally to quantum and classical optical communications, and in particular relates to transmitting qubits and classical bits of the same wavelength over an optical telecommunications network.

### BACKGROUND ART

QKD involves establishing a key between a sender (“Alice”) and a receiver (“Bob”) by using either single-photons or weak (e.g., 0.1 photon on average) optical signals (pulses) called “qubits” or “quantum signals” transmitted over a “quantum channel.” Unlike classical cryptography whose security depends on computational impracticality, the security of quantum cryptography is based on the quantum mechanical principle that any measurement of a quantum system in an unknown state will modify its state. Consequently, an eavesdropper (“Eve”) that attempts to intercept or otherwise measure the exchanged qubits introduced errors that reveal her presence.

The general principles of quantum cryptography were first set forth by Bennett and Brassard in their article “Quantum Cryptography: Public key distribution and coin tossing,” Proceedings of the International Conference on Computers, Systems and Signal Processing, Bangalore, India, 1984, pp. 175-179 (IEEE, New York, 1984). Specific QKD systems are described in U.S. Pat. No. 5,307,410 to Bennett (which patent is incorporated herein by reference), and in the article by C. H. Bennett entitled “Quantum Cryptography Using Any Two Non-Orthogonal States,” Phys. Rev. Lett. 68 3121 (1992), which article is incorporated by reference herein. The general process for performing QKD is described in the book by Bouwmeester et al., “The Physics of Quantum Information,” Springer-Verlag 2001, in Section 2.3, pages 27-33.

In a typical QKD system, Alice and Bob are optically coupled by an optical fiber that carries only the quantum signals used to establish a quantum key between them. Having such a dedicated connection facilitates detecting the quantum signals because there are no externally introduced sources of noise from other kinds of optical signals. Oh the other hand, it is contemplated that QKD systems will be arranged to form QKD networks in a manner that takes advantage of existing classical optical fiber telecommunication systems. However, incorporating QKD into such systems requires that the quantum signals share the same optical fiber as “classical” (i.e., non-quantum) optical signals used in standard optical telecommunications. This complicates the QKD process because detecting the quantum signals is hampered by the presence of the classical signals, as well as by the relatively large amounts of noise (e.g., scattered light) generated by the classical signals.

It has been proposed in U.S. Pat. No. 5,675,648 and in U.S. Patent Application Publication No. US2004/0250111 A1, entitled “Methods and systems for high-data-rate transmission in quantum cryptography,” to combine quantum signals and classical signals onto a single optical fiber using wavelength-division multiplexing. This requires transmitting the quantum signals on a substantially different wavelength band than the classical signals. The WDM approach for QKD is discussed in the article by Chapuran et al., entitled “Compatibility of quantum key distribution with optical networking,” Proc. SPIE Vol. 5815 (2005) (“Chapuran”). Chapuran teaches that the quantum and classical signals need to be transmitted in wavelength bands separated by at least 150 nm. While the WDM approach to combining quantum and classical signals is useful for increasing the QKD transmission rate, it does not allow for the quantum and classical signals to have the same frequency, i.e., both transmitting both types of signals over the same channel.

FIG. 1 is a schematic diagram of a generic prior art telecommunications system 10 capable of transmitting classical and quantum signals having the same wavelength. System 10 includes first and second classical transmit/receive (T/R) units 14A and 14B. T/R unit 14A is coupled to a QKD encryption unit 20A and T/R unit 14B is coupled to a QKD encryption unit 20B. QKD encryption unit 20A includes a QKD station Alice, a quantum key buffer 24A operably coupled to Alice, and an encryption/decryption (“e/d”) device 26A operably coupled to the quantum key buffer. Likewise, QKD encryption unit 20B includes a QKD station Bob, a quantum key buffer 24B operably coupled to Alice, and an e/d device 26B operably coupled to the quantum key buffer.

System 10 uses two different optical fiber communication links that carry optical signals of the same wavelength: a dedicated quantum optical fiber link FLQ that only carries quantum signals QS between Alice and Bob, and an existing classical optical fiber link FLC that is part of an existing optical telecommunications network and that carries only classical signals CS between T/R units 14A and 14B. The two optical fiber links FLQ and FLC represent separate quantum and classical optical paths—i.e., the optical paths do not have a portion of their path in common.

In operation, the QKD system defined by Alice, Bob and quantum optical fiber link FLQ forms quantum keys by transmitting and processing encoded quantum signals QS that travel between Alice and Bob over optical fiber link FLQ. The quantum keys are then stored in the respective quantum key buffers 24A and 24B. The quantum keys are then accessed and used by e/d devices 26A and 26B to form encrypted classical signals CS′ from the otherwise unencrypted classical signals CS used to communicate between T/R units 14A and 14B over classical optical fiber link FLC.

Because classical optical fiber link FLC exists as part of an optical telecommunications network, system 10 requires that a second optical fiber link be identified (and perhaps leased) or installed directly, to serve as a quantum communication link FLQ. The need for two separate optical fiber links is a major inconvenience as well as a major expense.

U.S. Pat. No. 5,675,648 to Townsend (hereinafter, “the '648 patent”) discloses a QKD system that uses a single optical fiber to carry a multi-photon public channel between the two QKD stations that uses the same wavelength as the quantum channel. The public channel is used to exchange information about the encoded quantum signals as part of the QKD process. However, in the '648 patent the multi-photon pulses for the public channel are actually generated by the QKD system itself. Accordingly, the '648 patent does not address the problem of having to deal with classical optical signals from an external source that are sent over an optical fiber of an existing optical telecommunications network into which the QKD system is integrated.

### SUMMARY OF THE INVENTION

One aspect of the invention is a method of transmitting same-wavelength qubits and classical signals of wavelength λ_{S} over an optical fiber of an optical telecommunications network. The method includes identifying a time interval ΔT₀ during which no classical signals of wavelength λ_{S} are present in the optical fiber. The method also includes sending qubits over the optical fiber during the time interval ΔT₀. The method also optionally includes using the transmitted qubits to perform QKD and banking the resulting quantum keys.

Another aspect of the invention is a method of forming and banking quantum keys using a classical optical telecommunications network. The method includes transmitting quantum bits and classical signals of the same wavelength λ_{S} over an optical fiber of an optical telecommunications system having first and second transmitting/receiving (T/R) units optically coupled to the optical fiber. The method also includes identifying a time interval ΔT₀ during which no classical optical signals of wavelength λ_{S} are present in the optical fiber. The method further includes sending qubits over the optical fiber during the time interval ΔT₀ so as to establish a plurality of quantum keys. The method also includes banking the plurality of quantum keys by storing the plurality of quantum keys in respective first and second quantum key buffers at the respective first and second T/R units. The method also includes using the stored quantum keys to encrypt and decrypt classical signals sent over the classical telecommunications network outside of the time interval ΔT₀.

Another aspect of the invention is a method of transmitting qubits and encrypted classical signals of the same wavelength λ_{S} over an optical fiber using banked quantum keys. The method includes sending the qubits over a quantum optical path that includes the optical fiber during a time interval ΔT₀ when there are no classical optical signals of wavelength λ_{S} traveling over the optical fiber, so as to form a plurality of quantum keys via a QKD process. The method further includes banking the quantum keys in first and second quantum key buffers. The method also includes sending the classical signals over a classical optical path that includes the optical fiber, wherein said sending occurs outside of the time interval ΔT₀, and encrypting and decrypting the classical signals using the banked quantum keys.

Additional features and advantages of the invention, such as systems for carrying out the above-summarized methods, are set forth in the detailed description that follows, and will be readily apparent to those skilled in the art from that description and/or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

Whenever possible, the same reference numbers or letters are used throughout the drawings to refer to the same or like parts.

### BRIEF DESCRIPTION OF THE DRAWINGS

FIG. 1 is schematic diagram of a prior art optical communication system that sends qubits and classical signals of the same wavelength over corresponding quantum and classical optical fiber links, with the classical optical fiber link being part of an existing optical telecommunications network;

FIG. 2 is a schematic diagram of an example embodiment of a classical-quantum optical communication system of the present invention formed by modifying the system of FIG. 1 so that only the classical optical fiber link is used to carry same-wavelength qubits and classical signals;

FIG. 3A is a close-up schematic diagram of an example embodiment of the Alice-side transmitting/receiving (T/R) unit having wavelength-division multiplexing (WDM) capability;

FIG. 3B is a close-up schematic diagram of an example embodiment of the present invention similar to that of FIG. 3A, but that includes a number of different Alice-side T/R units each transmitting at a different wavelength and optically coupled to a WDM;

FIG. 4 is a close-up schematic diagram of an example embodiment of the QKD station “Alice” having WDM capability for the qubits, the synchronization signal and the public channel signal;

FIG. 5A is a close-up schematic diagram of an example embodiment of a portion of the Alice-side QKD encryption unit wherein Alice is adapted to send qubits over a number of different channels when the corresponding classical channel has no traffic; and

FIG. 5B is a close-up schematic diagram of an example embodiment of a portion of the Bob-side QKD encryption unit as adapted to operate with the Alice-side QKD system of FIG. 5A.

### DETAILED DESCRIPTION OF THE PREFERRED EMBODIMENTS

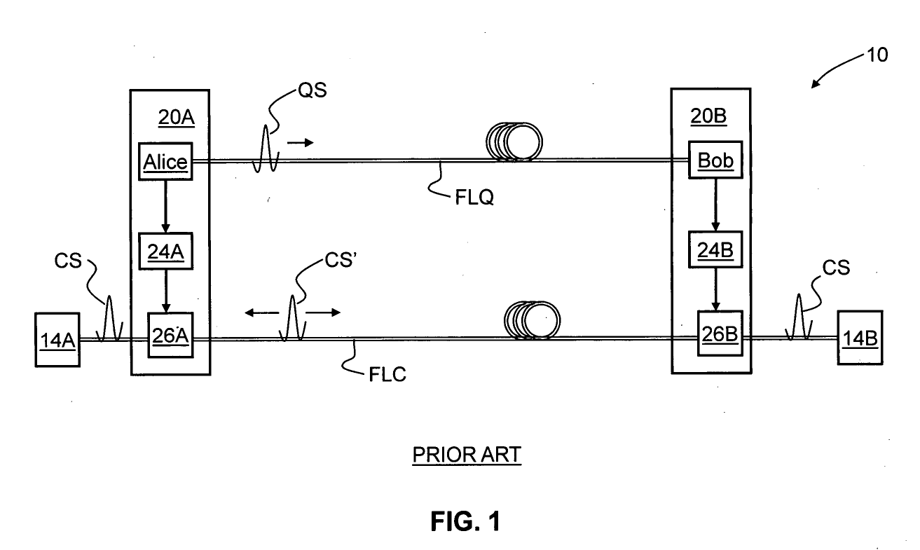

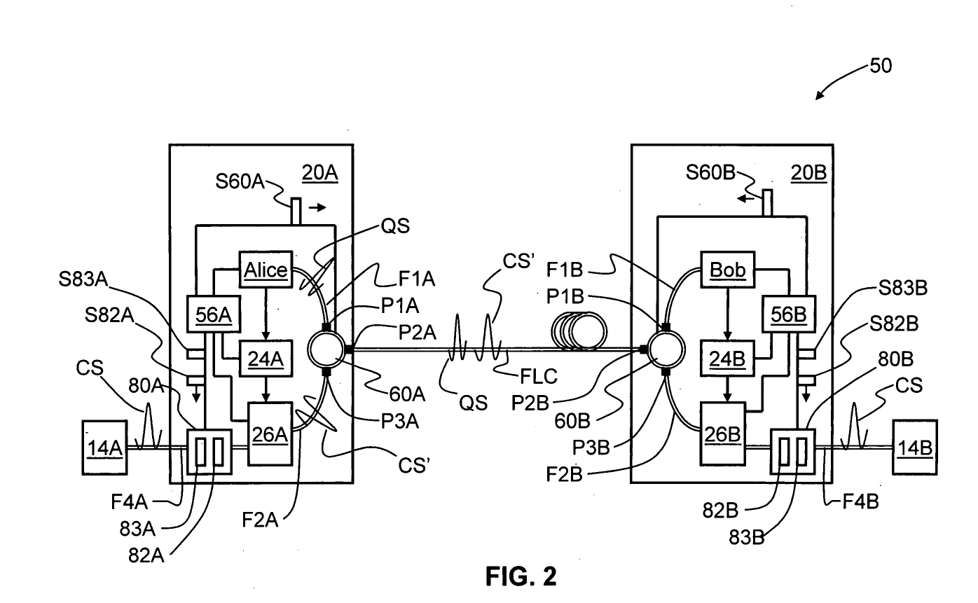

FIG. 2 is a schematic diagram of an example embodiment of a classical-quantum optical communication system 50 according to the present invention as used to carry out example embodiments of the methods of the present invention. System 50 has the same elements as system 10 of FIG. 1, except that system 50 is adapted to use the existing classical optical fiber link FLC to carry both classical signals (e.g., “classical bits”) of wavelength λ_{C} and quantum signals (i.e., qubits) of wavelength λ_{Q} when these two types of signals have the same wavelength λ_{S}=λ_{C}=λ_{Q}. In the discussion below, the terms “qubits” and “classical signals” are used.

In an example embodiment, Alice and Bob are adapted to exchange qubits for reasons other than for performing QKD, such as for quantum information processing, e.g., quantum computing operations. The example embodiments set forth below directed toward using the transmitted qubits to perform QKD and establish quantum key banks are specific example embodiments of the more general principle of the present invention, which is the transmission of same-wavelength qubits and classical bits over an optical-fiber-based telecommunications system.

QKD encryption units 20A and 20B of system 50 include respective controllers 56A and 56B. Controller 56A is operably coupled to Alice, to quantum key buffer 24A, and to e/d device 26A. Likewise, controller 56B is operably coupled to Bob, to quantum key buffer 24B, and to e/d device 26B. In an example embodiment, controllers 56A and 56B each include a microprocessor, a field-programmable gate array (FPGA), or other logic-based programmable medium adaptable (e.g., programmable) to carry out instructions to operate the system to perform the methods as described below.

QKD encryption unit 20A includes a three-port optical-signal-directing element (OSDE) 60A with ports P1A, P2A and P3A. Likewise, QKD encryption unit 20B includes a three-port OSDE 60B with ports P1B, P2B and P3B. OSDE 60A is optically coupled to Alice via an optical fiber section F1A coupled to port P1A, and is optically coupled to e/d device 26A via an optical fiber section F2A coupled to port P3A. Likewise, OSDE 60B is optically coupled to Bob via an optical fiber section F1B at port P1B and is optically coupled to e/d device 26B via an optical fiber section F2B at port P3B. OSDEs 60A and 60B are also optically coupled to respective ends of optical fiber link FLC at their respective ports P2A and P2B. OSDEs 60A and 60B are also respectively operatively coupled to controllers 56A and 56B. Respective optical fiber sections F4A and F4B optically couple respective T/R units 14A and 14B to their respective e/d devices 26A and 26B.

Optical fiber sections F1A and F1B, along with optical fiber link FLC constitute a quantum optical path over which qubits QS travel from Alice to Bob. Likewise, optical fiber section F2A and F2B, along with optical fiber link FLC constitute a classical optical path over which classical signals CS travel from T/R unit 14A to T/R unit 14B. Note that in this example embodiment, the quantum optical path and the classical optical have a common section—namely, existing classical optical fiber link OFC.

### Classical and Quantum Operational Modes

OSDEs 60A and 60B each have two operational modes that correspond to the quantum and classical signals traveling over their corresponding optical paths. In the “classical” mode, classical optical signals traveling on optical fiber section F2A and entering OSDE 60A at port P3A are outputted from port P2A and onto optical fiber link FLC, and vice versa. Likewise, in the classical mode, classical optical signals traveling on optical fiber section F2B and entering OSDE 60B at port P3B are outputted from port P2B and onto optical fiber link FLC, and vice versa.

In the “quantum” mode, qubits in the form of quantum optical signals QS traveling on optical fiber section F1A and entering OSDE 60A at port P1A are outputted from P2A and onto optical fiber link FLC, and vice versa. Likewise, in the quantum mode, quantum optical signals QS traveling on optical fiber section F1B and entering OSDE 60B at port P1B are outputted from port P2B and onto optical fiber link FLC, and vice versa

Controllers 50A and 50B control their respective OSDEs 60A and 60B to place them in one of the two operational modes using respective control signals S60A and S60B.

### “Classical Mode” of Operation

In the general method of operation of system 50 in the classical operational mode, OSDEs 60A and 60B are placed in the classical operational mode via respective control signals S60A and S60B. T/R unit 14A generates classical optical signals CS of wavelength λ_{C}=λ_{S} that travel over optical fiber section F4A to e/d device 26A in QKD encryption unit 20A.

In an example embodiment where the information embodied in classical optical signals CS (i.e., the plaintext) is to be encrypted, controller 56A activates e/d unit 26A, Which encrypts the plaintext represented by classical signals CS using the quantum keys stored in quantum key buffer 24A. The quantum keys are provided to the e/d device at the required keying rate. This process forms encrypted classical optical signals CS′ representing the corresponding cyphertext.

Encrypted classical signals CS′ travel from e/d device 26A over optical fiber section F2A to port P3A of OSDE 60A. OSDE 60A, being in the classical operational mode, directs encrypted classical signals CS′ out of port P2A and onto optical fiber link FLC.

Encrypted classical signals CS′ travel over optical fiber link FLC and enter QKD encryption unit 20B at port P2B of OSDE 60B. Being in the classical operational mode, OSDE 60B directs encrypted classical signals CS′ out of port P3B and onto optical fiber section F2B. Encrypted classical signals CS′ then enter e/d device 26B, which decrypts these signals based on the corresponding quantum key from quantum key buffer 24B, thereby recovering the classical signals CS and the corresponding plaintext.

In an example embodiment, a header is provided to encrypted classical signals CS′ when they are first encrypted so that quantum encryption unit 20A or 20B knows to decrypt these signals using their corresponding e/d device 26A or 26B and the corresponding quantum key from the corresponding quantum key buffer 24A or 24B. Note the classical portion of system 50 is symmetrical so that the same classical communication steps occur in reverse when transmitting encrypted classical signals CS′ from T/R unit 14B to T/R unit 14A.

In another example embodiment, some or all of the classical signals CS traveling between T/R unit 14A to T/R unit 14B are unencrypted.

### “Quantum Mode” of Operation

System 50 also includes a quantum operational mode wherein qubits in the form of qubits QS are sent over optical fiber link FLC. In practice, the amount of classical optical signal traffic that travels over optical fiber link FLC between T/R units 14A and 14B typically varies with time. This variation occurs on a variety of time scales, from short time scales (e.g., milliseconds, microsecond, and seconds) to long time scales (e.g., minutes and hours). For example, it may be that classical signals CS are not transmitted from T/R unit 14A to T/R unit 14B outside of a fixed time interval, such as outside of normal business hours, or certain hours of the day or night.

The present invention takes advantage of relatively long time intervals ΔT₀ (e.g., fractions of a second, seconds, minutes, and an hour or more) within which there are no classical optical signals (encrypted or non-encrypted) traveling over optical fiber link FLC. These intervals may be predetermined, i.e., they may be scheduled for set times so that one knows ahead of time when optical fiber link FLC will be “dark,” and for how long. They may also be established by system 50, as described below.

Aspects of the present invention are best suited for optical fiber communication systems that have or can be made to have a truly “dark” optical fiber link FLC. Here, the truly dark optical fiber has no “background” light present at the channel wavelength λ_{C}=λ_{S} when no classical signals are being transmitted.

Some optical fiber communication systems use transmission protocols that require the presence of a background light level at the channel wavelength λ_{S} even when no classical signals are being transmitted at that wavelength. Accordingly, an example embodiment of system 50 of the present invention includes adjustable filter units 80A and 80B respectively located in QKD encryption units 20A and 20B between the corresponding T/R units 14A and 14B and corresponding e/d devices 26A and 26B.

In an example embodiment, filter units 80A and 80B each include adjustable optical filters 82A and 82B that are respectively controlled by control signals S82A and S82B from respective controllers 56A and 56B to place the filters in either a transmitting state that transmits light of λ_{S} during the classical mode of operation, or a blocking state that blocks light of λ_{S} during the quantum mode of operation.

In an example embodiment, filter units 80A and 80B also include respective buffer units 83A and 83B that are controlled by control signals S83A and S83B from respective controllers 56A and 56B to store classical signals CS that arrive at filter units 80A and/or 80B but that are otherwise blocked from being transmitted by adjustable optical filters 82A and/or 82B. Buffer units 83A and 83B are adapted to convert the classical optical signals to electrical signals and electrically store the signals. Buffer units 83A and 83B are also adapted to convert the electrically stored classical signals back into classical optical signals. This allows for the classical traffic to be blocked and stored for relatively short time intervals ΔT₀ (e.g., on the order of seconds or fractions of a second) as well as longer time intervals (e.g., on the order of minutes or hours) while the quantum traffic travels over optical fiber link FLC.

The buffered classical signals are transmitted (or more accurately, re-transmitted) outside of the time interval ΔT₀. In an example embodiment, this includes time-division multiplexing the buffered signals with the classical signals transiting the classical optical path between T/R units 14A and 14B.

In an example embodiment of the invention, the duration of time intervals ΔT₀ are defined by how much information traveling in the classical communication channel can be buffered, and how much delay in the transmission of the classical information is acceptable to the optical telecommunication network end users (i.e., the parties at T/R units 14A and 14B).

In an example embodiment of the present invention, the time intervals ΔT₀ in which there are no classical optical signals (or other light) of wavelength λ_{S} carried on optical fiber link FL occur at a known time and have a known duration. For example, ΔT₀ may span evenings, select non-business hours and non-business days such as weekends and holidays, or a portion of each weekend or non-business day.

During such time intervals ΔT₀, controllers 56A and 56B place system 50 in the quantum operational mode wherein QKD encryption units 20A and 20B cause QKD stations Alice and Bob to operably communicate over optical fiber link FLC by exchanging qubits QS to form quantum keys, which are then stored in respective quantum key buffers 24A and 24B.

During time intervals ΔT₀, which in an example embodiment are programmed or otherwise inputted into controllers 56A and 56B, the respective controllers set OSDEs 60A and 60B to the quantum operational mode, which establishes the quantum optical path between Alice and Bob.

Thus, qubits QS travel over the quantum optical path from Alice to Bob. In an example embodiment use the qubits to carry out the known QKD processes to establish quantum keys. The quantum keys are then stored in quantum key buffers 24A and 24B.

In an example embodiment of system 50 where QKD is performed using the transmitted qubits, synchronization and calibration signals for performing QKD are sent over the optical fiber link FLC. These synchronization and calibration signals can have the same wavelength or different wavelengths as the qubits QS.

Further, public channel signals used to establish the quantum-signal encodings of Alice and Bob as part of the QKD protocol can have the same wavelength or a different wavelength as the qubits. The “same wavelength” approach is described in the '648 patent.

Usually, sync signals and quantum signals have different wavelengths. This simplifies QKD implementation and reduces the effect of backscattering from the sync channel. However, this same-wavelength approach requires that the sync signals be superimposed with the quantum signals, which presents difficulties in distinguishing the detection of quantum signal from the sync signals. One option to overcome such difficulties is to send a relatively intense sync signal from time to time. The sync signal intensity should be chosen such that it triggers the detector on receiver's side with high probability. The weaker quantum signals create random detector clicks while the sync signals create a periodic detector click pattern. The periodic sync signal pattern is extracted by digital processing of the detector signal and is used for synchronization purposes.

In an example embodiment where system 50 operates in the quantum operational mode during a relatively lengthy time interval ΔT₀, the system is able to build up a relatively large quantity (e.g., thousands) of stored quantum keys in quantum key buffers 24A and 24B. These quantum keys are then available for use by e/d devices 26A and 26B to encrypt the information embodied in classical optical signals CS sent between T/R units 14A and 14B during the classical operational mode of system 50 (i.e., outside of time interval ΔT₀).

Because qubits QS are transmitted during time intervals ΔT₀ wherein there are no classical signals present in the quantum optical path, the qubits can have the same wavelength λ_{S} as the classical optical signals. This allows qubits and classical signals to be placed on the same optical fiber and sent over the same channel, thereby obviating the need to purchase or lease an additional frequency to transmit quantum information over the same optical fiber.

In an example embodiment, QKD encryption unit 20A communicates with QKD encryption unit 20B using a first classical activation signal or a first classical signal header that informs QKD encryption unit 20B to go into quantum communication mode. Likewise, in an example embodiment, QKD encryption unit 20A communicates with QKD encryption unit 20B using a second classical activation signal or classical signal header that informs QKD encryption unit 20B to go into classical communication mode.

### Multiple-Wavelength Embodiments

Example embodiments of system 50 of the present invention include arrangements where multiple wavelengths are used in the QKD mode and/or in the classical mode.

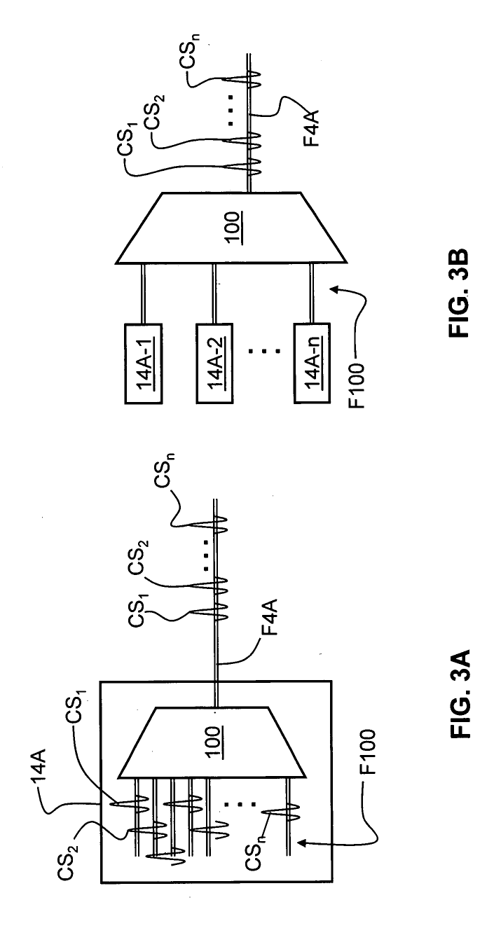

FIG. 3A is a schematic close-up diagram of an example embodiment of T/R unit 14A of FIG. 2, wherein the T/R unit is adapted to provide a number of classical signals CSₙ each having a different wavelength λₙ. T/R unit 14A of FIG. 3A includes a number of different optical fibers F100 that respectively carry the classical signals CSₙ. Optical fibers F100 are optically coupled to a wavelength-division multiplexer (WDM) 100, which in turn is optically coupled to optical fiber section F4A. This allows for the different-wavelength classical signals CSₙ (e.g., CS₁, CS₂, . . . CSₙ, where say CS₂ has a wavelength λ_{S}) to travel to T/R unit 14A for encryption and further travel over to T/R unit 14B as described above.

FIG. 3B is a close-up schematic diagram of an example embodiment of the present invention similar to that of FIG. 3A, but that includes a number (n) of different T/R units 14A-1, 14A-2, . . . 14A-n that respectively transmit classical signals CS₁, CS₂, . . . CSₙ having different wavelengths λ₁, λ₂, . . . λₙ, wherein one of these wavelengths is the same as λ_{S}. T/R units 14A-1, 14A-2, . . . 14A-n are optically coupled to WDM 100. WDM 100 is in turn optically coupled to optical fiber section F4A.

In an example embodiment, there are also corresponding T/R units 14B-1, 14B2, etc. coupled to QKD encryption unit 20B. This arrangement allows for a number of different T/R units to communicate with each other using different wavelengths, wherein one of the wavelengths is the same as the qubit wavelength.

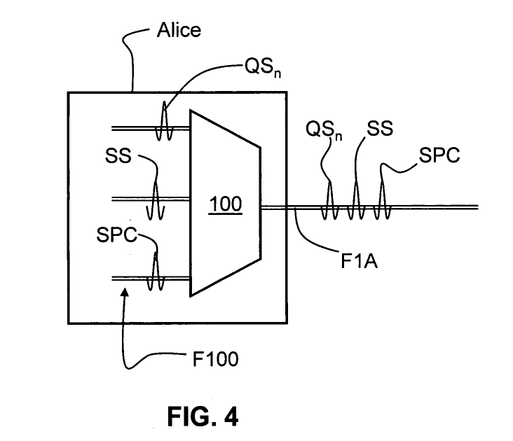

FIG. 4 is a schematic close-up diagram of Alice of FIG. 2, illustrating an example embodiment wherein Alice is adapted to provide a qubit QS of one wavelength, a synchronization signal SS of another wavelength, and a public channel signal SPC of a third wavelength. Alice includes three different optical fibers F100 that respectively carry qubit QS, synchronization signal SS and public channel signal SPC. In an example embodiment, the wavelength for the synchronization signal and the public channel signal are the same. Optical fibers F100 are optically coupled to a WDM 100, which in turn is optically coupled to optical fiber section F1A.

In one of the multi-wavelength embodiments, in the “classical mode” of operation, all n classical signals CSₙ are multiplexed onto optical fiber section F4A and travel over the classical optical path to T/R unit 14B, which in the present embodiment includes the same multi-wavelength configuration as the Alice-side of system 50. However, in the “quantum mode” of operation, at least one of the classical signals CSₙ—say, CS₄—is not transmitted over the classical optical path for a select time interval ΔT₀. During this time interval, the corresponding wavelength qubit QSₙ—here, QS₄—is transmitted over the quantum optical path as described above. Thus, rather than closing down all of the classical communication between the Alice-side and Bob-side of system 50, only one or more of the classical channels is shut down for the select time interval ΔT₀ to allow Alice and Bob to establish (or refresh) the bank of keys stored in quantum key buffers 24A and 24B. By closing down two classical signal channels, the synchronization signal SS and public channel signal SPC can share a channel having a different wavelength than the qubit QS. By closing down three classical signal channels, the qubit, the synchronization signal, and the public channel signal can each be sent at different wavelengths.

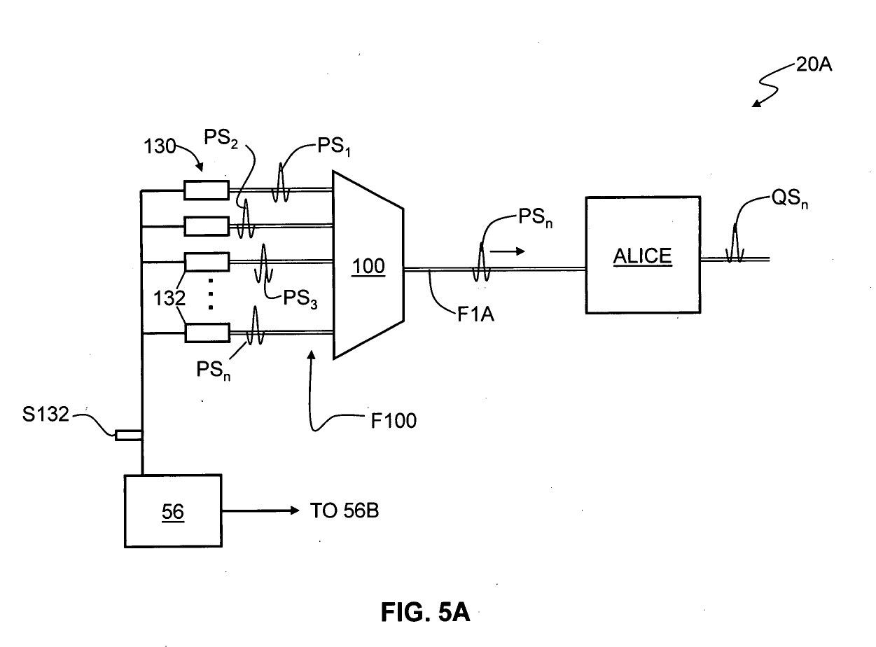

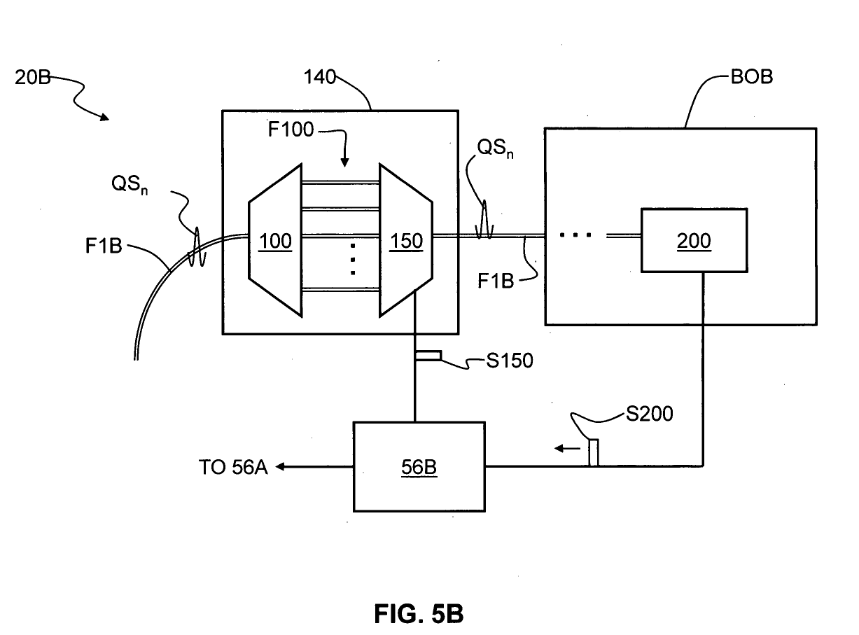

FIG. 5A is a close-up schematic diagram of a portion of the Alice-side of QKD encryption unit 20A, illustrating an example embodiment wherein the QKD encryption unit is adapted to send qubits over one or more different channels when the corresponding one or more classical channels have no traffic. QKD encryption unit 20A of FIG. 5A includes an array 130 of one or more light sources 132, wherein the light sources emit respective light pulses PS₁, PS₂, . . . PSₙ having different wavelengths. Light sources 132 are electrically coupled to controller 56A, which controls the activation of select light sources depending on the wavelength needed for qubits QS. In an example embodiment where light source array 130 includes a single light source 132, the light source is preferably a rapidly tunable laser.

In operation in the quantum mode, one of light sources 132 is activated by controller 56A via a control signal(s) S132, and the emitted light pulses are multiplexed onto optical fiber section F1A via multiplexer 100. The one or more emitted light pulses have the same wavelength as the corresponding one or more classical signals that are absent from the classical optical path during the time interval ΔT₀. The emitted light pulse(s) then proceeds to Alice, who converts the pulses to corresponding qubits QS (e.g., QS₁ or QS₂ . . . or QSₙ). Suitable light sources 132 may be, for example, vertical-cavity surface-emitting lasers (VCSELs). FIG. 5B is a close-up schematic diagram of a portion of the Bob-side QKD encryption unit 20B as adapted to operate with the Alice-side QKD encryption unit 20A of FIG. 5A. QKD encryption unit 20B includes signal-selecting assembly 140 arranged in optical fiber section F1B. Signal-selecting assembly 140 includes a WDM 100 and a 1×n optical switch 150 optically coupled by an array of optical fibers F100. When a qubit QSₙ of wavelength λₙ arrives at signal-selecting assembly 140, it is directed by WDM 100 into the appropriate optical fiber F100. The 1×n optical switch 150 is then directed by controller 56B via a control signal S150 to direct the qubit QSn from the 1×n optical switch over to Bob via the remaining optical fiber section F1B.

Note that in an alternative example embodiment, 1×n optical switch 150, which is essentially a multi-wavelength version of signal-directing element 60B and is referred to in the art as a “reconfigurable optical add/drop multiplexer,” and can replace OSDE 60B. In this embodiment, 1×n optical switch 150 is configured to direct classical signals CSₙ to optical fiber section F2B.

In an example embodiment, Bob includes a detector unit 200 adapted to detect single photons at different wavelengths. Detector unit 200 provides an electrical signal S200 in response to detecting a photon. Electrical signal S200 is processed by controller 56B according to standard QKD protocols.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A method of transmitting same-wavelength qubits and classical signals of wavelength λ_{S} over an optical fiber of an optical telecommunications network, comprising:
identifying a time interval ΔT₀ during which no classical signals of wavelength λ_{S} are present in the optical fiber; and
sending qubits over the optical fiber during the time interval ΔT₀.

2. The method of claim 1, including using the qubits to perform quantum key distribution (QKD).

3. The method of claim 2, including:
establishing a plurality of quantum keys using said QKD; and
banking the plurality of quantum keys in respective first and second quantum key buffers.

4. The method of claim 1, including:
sending classical signals over the optical fiber during a time outside of the time interval ΔT₀.

5. The method of claim 4, including encrypting and decrypting the classical signals using the banked quantum keys.

6. The method of claim 1, wherein the qubits travel over a quantum optical path and the classical signals travel over a classical optical path, wherein the optical fiber is shared by the quantum and classical paths, and including:
during the time interval ΔT₀, blocking light of wavelength λ_{S} from entering the quantum optical path from the classical optical path.

7. The method of claim 1, wherein the time interval ΔT₀ is defined by preventing classical signals from traveling over the classical optical path.

8. The method of claim 7, including buffering the classical signals prior to blocking the classical bits.

9. The method of claim 8, including transmitting the buffered classical signals over the optical fiber outside of the time interval ΔT₀.

10. A system for banking quantum keys, comprising;
first and second quantum key distribution (QKD) stations optically coupled by a quantum optical path that includes an optical fiber of a classical optical telecommunications network, wherein the first and second QKD stations are adapted to exchange qubits of wavelength λ_{S} over the quantum optical path so as to form quantum keys;
first and second transmitting/receiving (T/R) units optically coupled by a classical optical path that includes the optical fiber, wherein the first and second T/R units are adapted to exchange classical signals of wavelength λ_{S} over the classical optical path;
first and second quantum key buffers respectively operably coupled to the first and second QKD stations and adapted to store the quantum keys;
first and second encryption/decryption (e/d) devices respectively operably coupled to the first and second quantum key buffers and to the first and second T/R units and adapted to encrypt classical signals and decrypt encrypted classical signals transmitted over the classical optical path between the first and second T/R units;
first and second optical-signal-directing elements arranged so as to selectively direct the classical signals and the qubits onto the optical fiber; and
first and second controllers respectively operably coupled to the first and second optical signal directing elements so as to cause the first and second optical signal directing elements to direct the qubits onto and out of the optical fiber during a time interval ΔT₀ wherein there are no classical signals traveling over the optical fiber.

11. The system of claim 10, further including first and second optical filters adjustable to either transmit or block light of wavelength λ_{S} and respectively operably coupled to the first and second controllers and arranged in the classical optical path so as to either allow or prevent light of wavelength λ_{S} from entering the optical fiber via the classical optical path.

12. The system of claim 10, further including first and second buffer units arranged in the classical, optical path and adapted to store the classical signals as electrical signals during time interval ΔT₀ and to re-transmit the classical signals outside of the time interval ΔT₀.

13. A method of transmitting qubits and encrypted classical signals of the same wavelength λ_{S} over an optical fiber using banked quantum keys, comprising:
sending the qubits over a quantum optical path that includes the optical fiber during a time interval ΔT₀ when there are no classical signals of wavelength λ_{S} traveling over the optical fiber, so as to form a plurality quantum keys via a QKD process;
banking the quantum keys in first and second quantum key buffers;
sending the classical signals over a classical optical path that includes the optical fiber, wherein said sending occurs outside of the time interval ΔT₀; and
encrypting and decrypting the classical signals using the banked quantum keys.

14. The method of claim 13, including blocking light of wavelength λ_{S} from entering the quantum optical path from the classical optical path.

15. The method of claim 14, wherein the blocked light includes classical signals, and further including:
buffering the classical signals prior to their being blocked; and
transmitting the buffered classical signals outside of the time interval ΔT₀.

16. The method of claim 13, wherein no classical signals of any wavelength travel over the optical fiber during the time interval ΔT₀.

17. A method of forming and banking quantum keys using a classical optical telecommunications network, comprising:
transmitting qubits and classical signals of the same wavelength λ_{S} over an optical fiber of an optical telecommunications system having first and second transmitting/receiving (T/R) units optically coupled to the optical fiber.
identifying a time interval ΔT₀ during which no classical optical signals of wavelength λ_{S} are present in the optical fiber;
sending qubits over the optical fiber during the time interval ΔT₀ so as to establish a plurality of quantum keys; and
banking the plurality of quantum keys by storing the plurality of quantum keys in respective first and second quantum key buffers at the respective first and second T/R units.

18. The method of claim 17, including:
sending the classical signals from the first T/R unit to the second T/R unit over the optical fiber during a time outside of the time interval ΔT₀, wherein the classical signals are encrypted and decrypted using the banked quantum keys.

19. The method of claim 18, wherein the qubits travel over a quantum optical path and the classical signals travel over a classical optical path, and including during the time interval ΔT₀, blocking light of wavelength λ_{S} from entering the quantum optical path from the classical optical path.

20. The method of claim 17, wherein the time interval ΔT₀ is defined by blocking classical signals from traveling over the classical optical path for a select time duration.

21. The method of claim 20, including prior to blocking the classical signals:
buffering the classical signals; and
transmitting the buffered classical signals outside of the time interval ΔT₀.

22. The method of claim 18, including directing the qubits and the encrypted classical signals onto the optical fiber using an optical-signal-directing element (OSDE).

23. The method of claim 18, including sending the classical signals through a first quantum encryption unit adapted to encrypt and decrypt the classical signals using quantum keys stored in the first quantum key buffer.

24. The method of claim 18, including sending the encrypted classical signals through a second quantum encryption unit adapted to encrypt and decrypt the encrypted classical signals using quantum keys stored in the second quantum buffer.

25. The method of claim 24, including placing a header onto the encrypted signals at one of the first and second quantum encryption units so that the other quantum encryption unit knows to decrypt the encrypted classical signals.
